(19) United States
(12) Patent Application Publication
(10) Pub. No.: US 2013/0029572 A1
(43) Pub. Date: Jan. 31, 2013

(54) Apparatus for washing and rinsing bivalves

(71) Applicant: Brent David Sausser, Washington, DC (US)

(72) Inventor: Brent David Sausser, Washington, DC (US)

(21) Appl. No.: 13/194,973

(22) Filed: Jul. 31, 2011

(51) Int. Cl. A22C 29/04

(52) U.S. Cl. 452/12

(57) ABSTRACT

An apparatus for washing and rinsing bivalves and other mollusks. The bivalves are placed in a hemisphere-shaped strainer and another hemisphere-shaped strainer is attached thereto to form a spherical strainer cage. The spherical strainer cage is mounted on a stand so that it may rotate freely about its axis. The cage rotates on the stand and a rinsing liquid is applied to remove debris from the bivalves contained in the cage.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### FIELD OF THE INVENTION

The present invention relates to a non-commercial bivalve washing apparatus for washing and cleaning bivalves or other mollusks, wherein the bivalves are placed in a half hemisphere-shaped strainer that closes and locks to create a spherical cage that mounts to a separate stand. The operator rotates the spherical cage on the stand and sprays a rinsing liquid to remove debris.

### BACKGROUND OF THE INVENTION

Oyster roasts and clambakes are a family and social event enjoyed worldwide. After harvesting oysters, clams, and other mollusks it is appropriate to wash them thoroughly in preparation for consumption. The casual cook generally purchases unclean bivalves from a commercial fisherman or harvests bivalves directly from their habitat. The non-commercial cleaning of bivalves becomes more popular as personal preparation increases. Currently, the only prior art cleaning devices available are commercial cleaners, bulky, difficult to move mechanical devices, or devices requiring surface water. These devices create obstacles for the occasional cook when preparing bivalves for consumption.

Commercial bivalve cleaners offer optimal cleaning options for commercial fisheries. However, these devices are specifically made for large packing companies and are often large conveyor belt-type devices. To the casual cook these devices are impractical on account of their large size. Prior art using bulky devices, as in the case of U.S. Pat. No. 6,508,699, provide additional disadvantages to the casual cook. These mechanical devices often include heavy parts that make the device difficult to move. In addition, mechanical parts wear faster through abrasion due to the friction of the constantly moving components.

Further, cylinder-shaped washers, such as U.S. Pat. No. 4,324,020 have additional deficiencies. Current devices using a cylindrical housing approach risk rinsing the bivalves without shuffling. A cylinder-shaped drum either flips the bivalve front over back or causes the bivalve to slide along the bottom. Either result does not rinse the bivalve in all directions. Additionally, this prior art requires surface water, normally found after removing bivalves from their bed or habitat. The casual cook is generally not around surface water when preparing oysters or clams for consumption. Furthermore, some devices run the bivalves continuously through stagnant water sitting at the bottom of a drum. This repetitively coats the bivalves with unclean or contaminated water. Other methods of washing, such as spraying them on the ground or concrete, fail to clean the bivalves in all directions as well as cause undesirable results (such as spraying bivalves away from the designated spraying area or gathering mud residue from the ground).

Important aspects of the field of invention need improvement. The full advantages of the present invention are further explained herein.

### SUMMARY OF THE INVENTION

As a result of the aforementioned impediments to washing bivalves, it is the object of this invention to provide an easily portable and efficient apparatus to thoroughly clean bivalves in preparation for consumption.

In one aspect, the present invention offers an easy to move option for the occasional cook. The lightweight spherical cage and stand are compact and easily portable.

In another aspect, the spherical-shaped cage combined with the internal protrusions allow for the shuffling of the bivalves upon rotation. This shuffling moves the bivalves front over back and side-to-side allowing the rinsing liquid to remove debris from all parts of the shell.

Further, it is another aspect that the bivalves are showered with a clean flow of liquid and lifted off the ground during cleaning, both of which further cut down on contamination.

In accordance with the present invention, a bivalve washing apparatus is comprised of two half-sphere perforated strainers, an axis that extends on opposite ends of the bottom half-sphere frame, and a stand, which includes two sides and stabilizing poles.

In one embodiment of the apparatus, the bottom half-sphere perforated strainer rests on its extended axis in the center depressions of two trapezoid-shaped walls. The operator places the desired number of oysters within the bottom half-sphere strainer. After placement, the top half-sphere perforated strainer fits snuggly on top of the bottom strainer. Multiple latching devices hold the two halves together to form a spherical cage. The stand maintains its sturdiness by four stabilizing poles reaching from one side of the stand to the other (two poles each placed on opposing ends of the stand). The stabilizing poles are positioned so that the handle of the spherical cage does not make contact with the poles during rotation. The cage rotates 360 degrees on the stand. The operator rotates the spherical cage and applies a rinsing liquid. The rinsing liquid, gravity and slight centrifugal force remove debris from the oysters during washing. While this and other embodiments focus on oysters, other bivalves may be used in the apparatus with equivalent effectiveness.

In another embodiment of the apparatus, a smaller bottom half-sphere perforated strainer fits in, but does not make contact with, a larger half-sphere perforated strainer. The smaller strainer contains an axis on its frame that extends on opposite sides, which provides the two arms wherein the spherical cage rests on the stand. This extended axis also fits through two, similarly placed, holes on opposite sides of the larger strainer. In its closed state the larger top strainer locks down on to the bottom smaller strainer. When opening, the larger top strainer will rotate under the smaller bottom strainer. This embodiment permits the operator to place the oysters in the rotating cage without removing any parts of the apparatus (except a latching device, where applicable). Once the oysters are placed in the smaller strainer the larger strainer rotates on its axis to close over the top of the smaller strainer. After it's closed, the operator locks the spherical cage and rotates the spherical cage on the stand. During rotation the operator applies a rinsing liquid to remove debris.

In some embodiments of the apparatus, the size of the stand and spherical cage will vary. Preferably, the size differences will correspond with bushel volume. The largest, as identified in the claims, will hold at least a bushel of oysters.

The following detailed description and embodiments will further explain the advantages and principles of the present invention.

### BRIEF DESCRIPTION OF THE SEVERAL VIEWS OF THE DRAWING

FIG. 1 illustrates a three-dimensional view of the 100 bivalve washing apparatus in accordance with embodiments of the invention.

FIG. 2 illustrates a front perspective view of the 100 bivalve washing apparatus.

FIG. 3 illustrates a horizontal side view of the 100 bivalve washing apparatus in the closed position.

FIG. 4 illustrates a horizontal side cross-sectional view of the 100 bivalve washing apparatus in the closed position.

FIG. 5 illustrates a horizontal side view of the 100 bivalve washing apparatus in the open position.

FIG. 6 illustrates a top perspective view of the 100 bivalve washing apparatus.

FIG. 7 illustrates a front perspective view of the 200 spherical strainer cage.

### DETAILED DESCRIPTION OF THE INVENTION

The following description is a preferred embodiment of the invention through example with reference to the accompanying drawings.

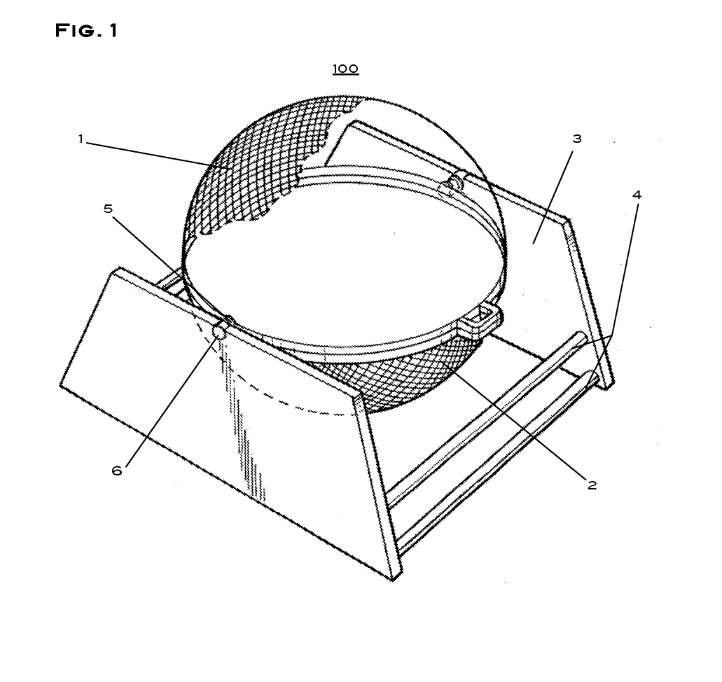

Referring to FIG. 1, a 100 bivalve washing apparatus according to the present invention comprises two hemisphere-shaped strainers. A first, 1 top hemisphere-shaped strainer rotates to close on top of a second smaller 2 bottom hemisphere-shaped strainer to form an imperfect spherical cage. The spherical cage is covered with a plurality of apertures, large enough to allow liquid to pass through, yet small enough to hold the bivalves within the cage. This embodiment illustrates a transparent 1 top hemisphere-shaped strainer and depicts a partial view of the apertures. The apertures pictured are approximately two centimeters in length and width, however other sizes may be utilized with equivalent effectiveness. The spherical cage protrudes two 5 side rods on opposite sides of the smaller 2 bottom hemisphere-shaped strainer's frame to form its axis. The axis does not penetrate the cage, as this would impede cage function, but rather affixes to the outside frame of the 2 bottom hemisphere-shaped strainer. The 5 side rods possess perpendicular 6 rotational guides to hold the imperfect spherical cage in place as it rotates. The spherical cage is integrally formed with strong and durable material. Preferably, the spherical cage is made of metal or a durable plastic that is resistant to abrasion and salt water corrosion. The spherical cage rotates on a stand made up of two parallel 3 side walls, which are held together by 4 stabilizing rods. The 4 stabilizing rods may be tubular or any other geometric shape. Further, this and other embodiments herein illustrate a spherical cage with an approximate diameter of 50 centimeters. A bushel of oysters are normally based on the U.S. bushel, which is 2,150.42 cubic inches or 35,239.070 cubic centimeters. This spherical cage has an approximate capacity of 65,450 cubic centimeters. This embodiment illustrates a spherical cage that holds at least one bushel of oysters as well as provides an empty space within the spherical cage to assist with the tumbling and shuffling of the bivalves upon rotation. Other sized spherical cages may be used with comparable effectiveness.

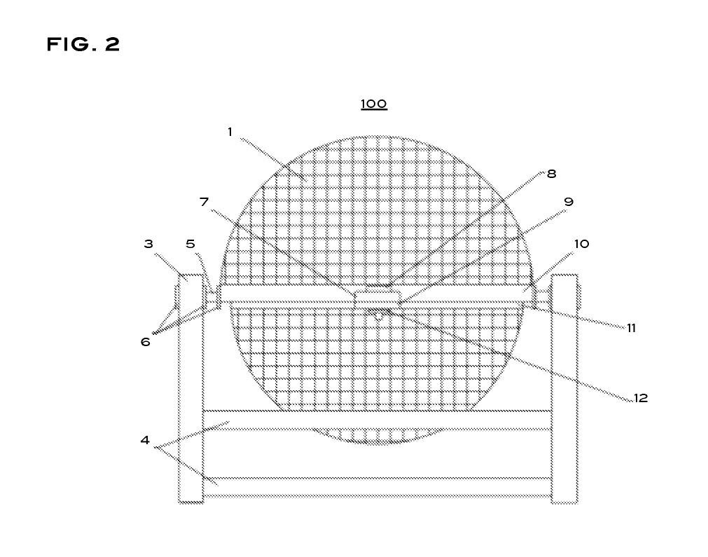

Referring now to FIG. 2, the 100 bivalve washing apparatus, the 10 frame of the 1 top hemisphere-shaped strainer rotates to close on to the 11 frame of the bottom hemisphere-shaped strainer. The two hemispheres conjoin via the 7 handle of the 1 top hemisphere thereby latching to the 9 handle of the bottom hemisphere. A 8 latching device secures the two handles (7, 9). The 8 latching device shown in this embodiment contains a 12 pin to lock the latch in place. Appertaining to this and other embodiments herein, other latching devices may be used for comparable effectiveness. The spherical cage rotates on the axis (the 5 side rods) of the apparatus, which is held in place by the 6 rotational guides. The 6 rotational guides, affixed to the 5 side rods, prevent the spherical cage from shifting to an unwanted rotating position. The 5 side rods rest in the 3 stand at the stationary position. The 4 stabilizing rods provide support for the 3 stand in the stationary position and during rotation.

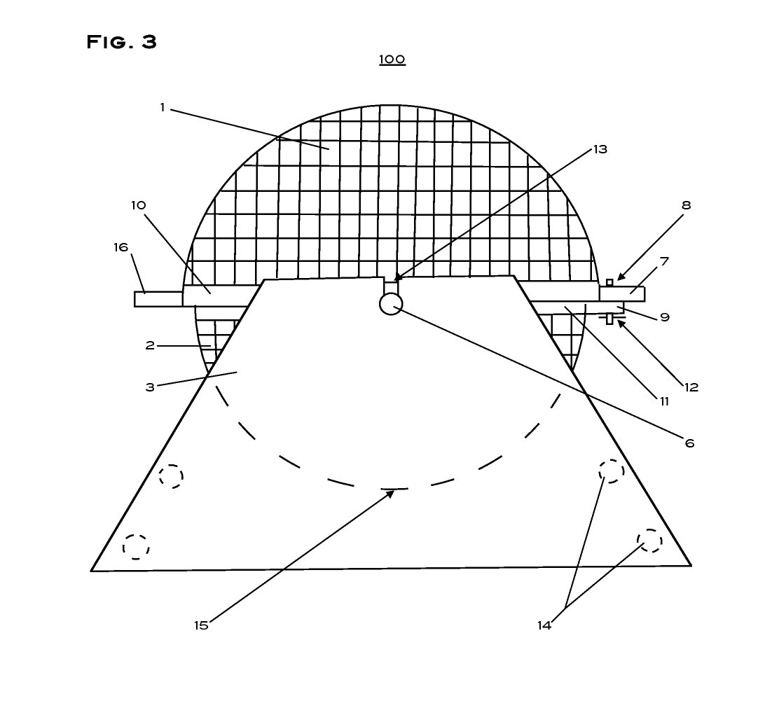

FIGS. 3, 4, and 5 represent different side views of the 100 bivalve washing apparatus. Referring to FIG. 3, the 100 bivalve apparatus shown in its closed state. The 8 latching device holds the 7 handle of top hemisphere together with the 9 handle of the bottom hemisphere to close the apparatus in preparation for rotation. Once closed, the operator rotates the cage and applies a rinsing liquid. This embodiment shows the 13 fitting slot on the 3 side wall whereby the side rod of the spherical cage fits thereto. The 6 rotational guides on the axis and at the end of the side rod are larger in size than the 13 fitting slot to prevent lateral movement. The 3 stand contains 14 outlines of the stabilizing rods, which are placed outside the 15 circumference of the 2 bottom hemisphere-shaped strainer as well as outside of the circumference of the 16 second handle of the 1 top hemisphere-shaped strainer to permit a 360° rotation.

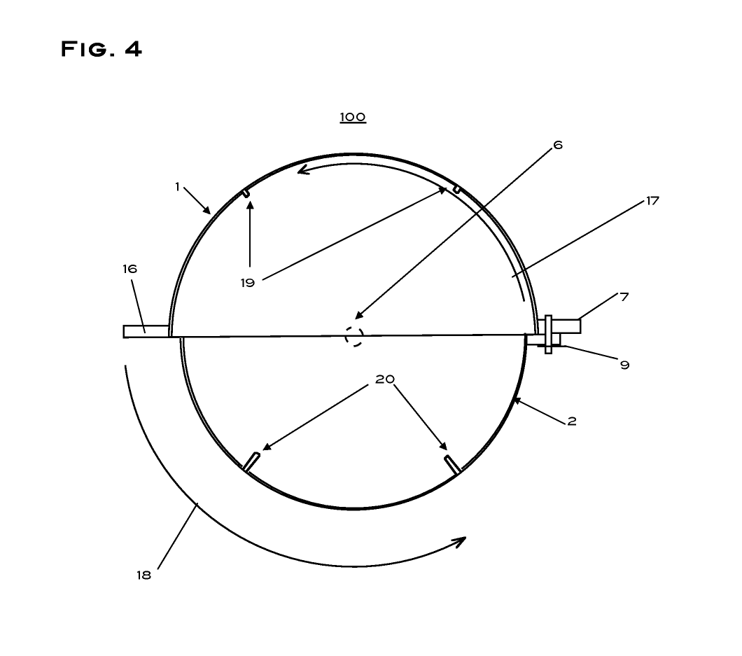

Referring now to FIG. 4, cross-sectional view of the 100 bivalve washing apparatus excluding the stand assembly. The 20 extended internal protrusions mount on the interior of the 2 bottom hemisphere-shaped strainer and assist in shuffling bivalves when rotating. 19 Smaller internal protrusions are placed on the 1 top hemisphere-shaped strainer. As illustrated, the approximate length of the 19 smaller internal protrusions are one centimeter in length and are designed to fit between the approximate two centimeters gap between the 1 top hemisphere-shaped strainer and the 2 bottom hemisphere-shaped strainer when rotating and in the open position. As illustrated, the approximate length of the 20 extended internal protrusions are three to four centimeters. All four internal protrusions (19, 20) run across the perimeter of the internal surface of the imperfect spherical cage as well as immovably adhere to the interior of both half-sphere shaped strainers to aid in shuffling the bivalves. Other modifications or permutations of the internal protrusions may be used with equivalent effectiveness. The 17 first rotational arrow shows the direction and rotational circumference of the 2 bottom hemisphere-shaped strainer when rotating to the open position. The 18 second rotational arrow shows the 16 second handle's rotational circumference when rotating to the open position. As shown in FIG. 3, the 18 rotational circumference of the second handle should fit on the inside of the stabilizing poles. For perspective purposes, the outline of the end 6 rotational guide is shown.

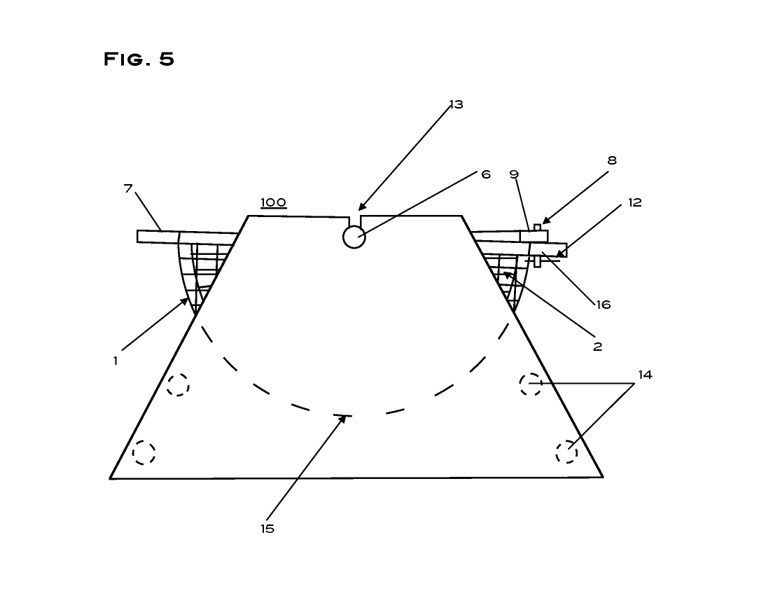

FIG. 5 illustrates the 100 bivalve washing apparatus shown in its open state. In this embodiment the 16 second handle of the 1 top hemisphere-shaped strainer rotates on its axis to affix to the 9 handle of the bottom hemisphere by means of the 8 latching device. In this illustration the larger diameter of the 1 top hemisphere-shaped strainer is evident. The smaller 2 bottom hemisphere-shaped strainer sits inside of, but does not make contact with, the larger 1 top hemisphere-shaped strainer. This embodiment illustrates an approximate two centimeters distance between the two hemisphere-shaped strainers. The distance between the two hemisphere-shaped strainers prevents the bivalves, held in the smaller 2 bottom hemisphere-shaped strainer, from making contact with the rotating larger 1 top hemisphere-shaped strainer. As a result, it allows an impediment free 360° rotation for the 1 top hemisphere-shaped strainer. Other spacing distances may be used for equivalent effectiveness based on the size of apertures. In operation, unclean bivalves are placed in the 2 bottom hemisphere-shaped strainer; the 1 top hemisphere-shaped strainer rotates to close on top of the 2 bottom hemisphere-shaped strainer, and locks into place via a 8 latching device; once locked, the operator rotates the spherical cage, tumbling the internal bivalves, and applies a rinsing liquid on the bivalves through the cage apertures; the debris falls free from the shell and is released, with the applied rinsing liquid, through the bottom apertures; once the bivalves are cleaned to satisfaction, the operator places the spherical cage back to its starting position with the 2 bottom hemisphere-shaped strainer facing the ground, and opens the spherical cage by releasing the lock and rotating the 1 top hemisphere-shaped strainer under the 2 bottom hemisphere-shaped strainer; the operator then locks the two hemispheres together to prevent unwanted movement and removes the clean bivalves.

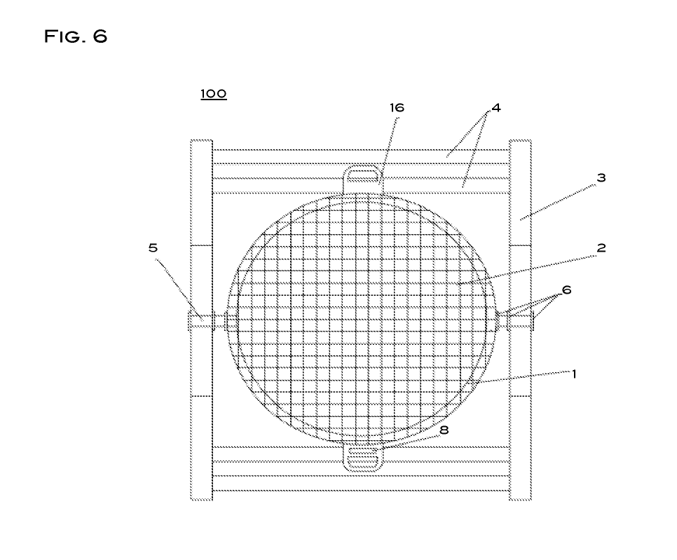

FIG. 6 shows an overhead view of the 100 bivalve washing apparatus in the closed position. From this view it is evident that the 5 side rods fit into the fitting slot on the 3 side walls. The 6 rotational guides hold the spherical cage in place within the fitting slot when stationary or rotating. This embodiment places a 6 rotational guide upon the end of both 5 side rods. Other variations may include an extended 5 side rod, on either side, projecting from the end 6 rotational guide and possessing a handle or crank for purposes of assisting the operator with rotation. In addition, this image illustrates how the larger diameter 1 top hemisphere-shaped strainer fits on top of the 2 bottom hemisphere-shaped strainer and how it connects by means of the 8 latching device.

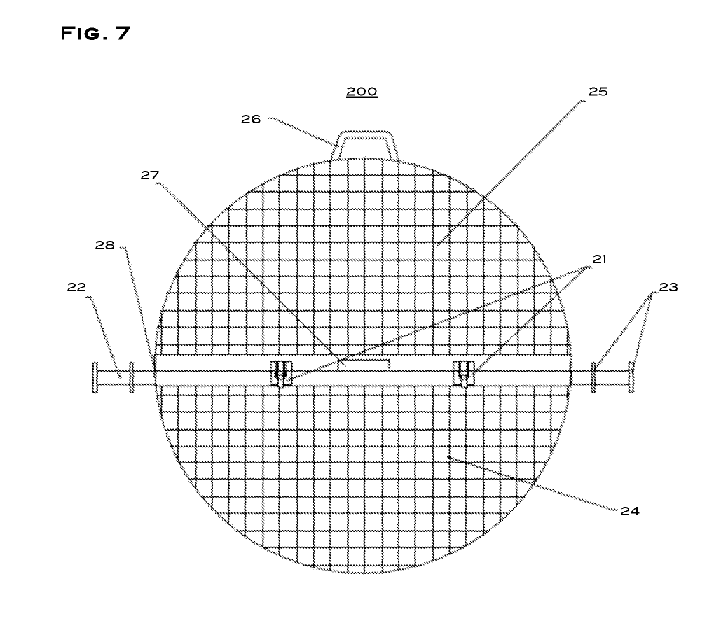

Finally referring to FIG. 7, a preferred embodiment of the present invention showing the 200 bivalve washing apparatus excluding the stand assembly. This embodiment comprises a 24 bottom hemisphere-shaped strainer projecting two 22 side rods from its axis. Fastened to the 22 side rods are 23 rotational guides preventing lateral movement. The 25 top hemisphere-shaped strainer situates on top of the equally sized 24 bottom hemisphere-shaped strainer by fitting into a 28 perimeter groove. The 24 bottom hemisphere-shaped strainer attaches to the 25 top hemisphere-shaped strainer by way of multiple 21 latching devices around the 28 perimeter groove. This embodiment shows one of two 27 side handles attached to the 25 top hemisphere-shaped strainer as well as positioned between two 21 latching devices. Other permutations of the handle position or latch position may be used with comparable effectiveness. Similarly, as mentioned in FIG. 2, other latching devices can be used with comparable effectiveness. The 26 top handle attaches to the top center of the 25 top hemisphere-shaped strainer. In operation, unclean bivalves are placed in the 24 bottom hemisphere-shaped strainer; the 25 top hemisphere-shaped strainer is placed on top of the 24 bottom hemisphere-shaped strainer in the 28 perimeter grove, and locks into place via multiple 21 latching devices; once locked, the operator rotates the spherical cage, tumbling the internal bivalves, and applies a rinsing liquid on the bivalves through the cage apertures; the debris falls free from the shell and is released, with the applied rinsing liquid, through the bottom apertures; once the bivalves are cleaned to satisfaction, the operator places the spherical cage back to its starting position with the 24 bottom hemisphere-shaped strainer facing the ground, and opens the spherical cage by releasing the locks and removing the 25 top hemisphere-shaped strainer by lifting the 26 top handle and removing the clean bivalves.

The descriptions above are provided in relation to the preferred embodiments of the invention and are not meant to limit the present invention to those depictions provided herein. The above detail allows one skilled in the art to make and use the invention. However, modifications, variations, or other equivalent arrangements can be used limited only by the listed appended claims.

1. An apparatus, comprising:
a stand having two separate structures which are parallel side panels held together by stabilizing rods; a first hemisphere-shaped strainer rotatably mounted to the pair of parallel side panels of the stand;
a second hemisphere-shaped strainer, the second hemisphere shaped strainer attachable to the first hemisphere-shaped strainer to form a spherical shaped strainer; and
a locking device selected from the group consisting of a lock and pin, slam latch, spring latch, bolt lock latch, or draw latch for securing the first hemisphere-shaped strainer to the second hemisphere-shaped strainer,
wherein the exterior surface of the first hemisphere-shaped strainer is covered with a first plurality of apertures that pass through to the interior,
wherein the exterior surface of the second hemisphere-shaped strainer is covered with a second plurality of apertures that pass through to the interior,
wherein the spherical-shaped strainer is rotatable about an axis perpendicular to the stand, and
wherein the second hemisphere-shaped strainer and the first hemisphere-shaped strainer have internal protrusions extending towards the interior thereof.

2. The apparatus of claim 1, wherein the first and second pluralities of apertures have a geometric shape.

3. The apparatus of claim 1, wherein the second hemisphere-shaped strainer has a diameter between 20 centimeters and 100 centimeters and the first hemisphere-shaped strainer having a similar diameter to the second hemisphere-shaped strainer between 20 centimeters and 100 centimeters.

4. The apparatus of claim 1, wherein the second hemisphere-shaped strainer has a first diameter and the first hemisphere-shaped strainer has a second diameter, and
wherein the first diameter and the second diameter are within the range of 0.01 centimeters to 2 centimeters of each other.

5. The apparatus of claim 1, wherein at least one of the first hemisphere-shaped strainer and the second hemisphere-shaped strainer have at least one handle mounted on a surface thereof.

6. (canceled)

7. The apparatus of claim 1, wherein the stand includes at least one rod disposed along the axis, and
wherein the first hemisphere-shaped strainer is connected to at least the one said rod.

8. The apparatus of claim 1, wherein the first and second pluralities of apertures are 0.01 centimeters to 4.5 centimeters in height and width.

9. An apparatus, comprising:
a stand having two separate parallel structures, which includes two side panels, a first side panel and a parallel second side panel held together by stabilizing rods;
an axle mounted between the first side and second side;
a first strainer having a hemisphere-shape and mounted on the axle across a first diameter of the first strainer;
a second strainer having a hemisphere-shape and mounted on the axle across a second diameter of the second strainer; and a locking device selected from the group consisting of a lock and pin, slam latch, spring latch, bolt lock latch, or draw latch for securing the first strainer to the second strainer,
wherein the exterior surface of the first hemisphere-shaped strainer is covered with a first plurality of apertures that pass through to the interior,
wherein the exterior surface of the second hemisphere-shaped strainer is covered with a second plurality of apertures that pass through to the interior,
wherein the first diameter is larger than the second diameter,
wherein the axle is mounted along an axis, and the first strainer and the second strainer are rotatable about the axis,
wherein the second hemisphere-shaped strainer and the first hemisphere-shaped strainer have internal protrusions extending towards the interior thereof,
wherein the diameter of the second strainer is between 20 centimeters and 100 centimeters and the diameter of the first strainer is between 20 centimeters and 100 centimeters, and
wherein the diameter of the first strainer is between 1 to 6 centimeters larger than the diameter of the second strainer.

10. The apparatus of claim 9, wherein the first and second pluralities of apertures have a geometric shape.

11. (canceled)

12. The apparatus of claim 9, wherein at least one of the first hemisphere-shaped strainer and the second hemisphere-shaped strainer have at least one handle mounted on a surface thereof.

13. (canceled)

14. The apparatus of claim 9, wherein the stand includes at least one rod that is rotatable about the axis.

15. (canceled)

16. The apparatus of claim 9, wherein the first and second pluralities of apertures are 0.01 centimeters to 4.5 centimeters in height and width.
